(19) United States
(12) Patent Application Publication
(10) Pub. No.: US 2026/0078634 A1
(43) Pub. Date: Mar. 19, 2026

(54) DOOR SEAL

(71) Applicant: Surelock McGill Limited, Workingham (GB)

(72) Inventor: Glen Davies, Reading (GB)

(21) Appl. No.: 19/327,381

(22) Filed: Sep. 12, 2025

(30) Foreign Application Priority Data
Sep. 19, 2024 (GB) 2413770.5

(51) Int. Cl. E06B 7/215; E06B 7/205

(52) U.S. Cl. CPC E06B 7/215; E06B 7/205

(57) ABSTRACT

A movable seal for mounting to a door, the moveable seal including a drop-plate configured to move to close or cover a gap between a bottom of a door and a floor, a plunger extending laterally configured to be pressed by a door frame as the door closes, a slider arranged to be moved laterally by the plunger when the plunger is pressed, the slider having one or more ramp surfaces, and one or more first rollers. The slider is configured such that when pushed laterally by the plunger the one or more ramp surfaces push against the one or more first rollers moving the drop-plate transversely to extend the drop plate outwards for closing or covering the gap to the floor.

### RELATED APPLICATIONS

This application claims priority to United Kingdom application number 2413770.5, filed Sep. 19, 2024, the disclosure of which is incorporated herein by reference in its entirety.

### TECHNICAL FIELD

The present invention relates to a movable seal for a door. In particular, the movable seal may be a security seal and includes a drop-plate which closes a gap at the bottom of a door when the door is closed.

### BACKGROUND

When a door closes at the base of a door there may be a gap. Gaps tend not to be present at the sides or above a door because the door closes against the door frame or door jamb which covers any gaps. At the base of the door if there is not a door frame at the bottom, for example with continuous flat floors passing under the door, there may be a gap between the base of the door and the floor. Gaps below doors can allow wires to be fed under the door to try to release locks, or can be used for passing fibre optics under the door for observing activities or contents on the other side of the door.

AU 2012-101071 describes a secure under-door seal in which as the door closes a door frame contacting member pushes a bar that rotates offset cams. The rotation of the cams moves a sealing member downwards to close a gap at the bottom of the door. The secure under-door seal has a number of problems in relation to high friction, inefficient biasing, difficulty of adjustment and a lack of compactness. Accordingly, it is desirable to provide an improved door seal.

### SUMMARY OF THE INVENTION

The present invention provides a movable seal for mounting to a door. The door seal may be a security door seal. The movable seal comprises: a drop-plate configured to move to close or cover a gap between a bottom of a door and a floor; a plunger extending laterally configured to be pressed by a door frame as the door closes; a slider arranged to be moved laterally by the plunger when the plunger is pressed, the slider having one or more ramp surfaces; and one or more first rollers, wherein the slider is configured such that when pushed laterally by the plunger the one or more ramp surfaces push against the one or more first rollers moving the drop-plate transversely to extend the drop plate outwards for closing or covering the gap to the floor. The slider and/or plunger may be configured to move substantially laterally only, for example to reduce or eliminate friction when pushing against a door frame. The first rollers, which are pushed by the ramp surfaces, are provided to reduce friction and so reduce the force required to extend the drop-plate. The rolling action of the first rollers against the ramp surfaces also reduces wear of the ramp surfaces and the surfaces or components pushed by the ramp surfaces. Although the movable seal may be a security seal for preventing wires, fibre optics and other items being fed under a door, in other embodiments the door seal may be a weather seal, flood seal, RF seal or an acoustic seal.

The one or more first rollers may be coupled to the drop-plate and may be configured such that as the slider moves laterally the ramp surfaces push against the first rollers pushing the plate outwards.

The movable seal may further comprise: a mounting plate for mounting the movable seal to a door; and one or more second rollers coupled to the mounting plate for guiding the lateral motion of the slider. As well as guiding the lateral motion of the slider, the second rollers also reduce friction acting against movement of the slider.

The one or more second rollers may comprise one or more pairs of second rollers with the rollers in a pair of second rollers arranged on opposing sides of the slider to constrain motion of the slider substantially laterally.

The one or more pairs of second rollers may comprise at least two pairs of second rollers, a first pair of second rollers arranged towards a first end of the slider and a second pairs of second rollers arranged towards a second end of the slider. The first end may be the end closest to the plunger and the second end may be the end distal to the plunger.

The slider may comprise parallel recesses and the second rollers may be arranged to roll along the parallel recesses.

The slider may comprise two parallel plates with the drop-plate there between.

The plunger may comprise a rod biased to extend from the slider to be pressed by a door frame.

The rod of the plunger may have a threaded portion extending through a threaded hole in the slider for adjusting the extent the plunger extends, for example from a housing or casing of the movable seal.

The drop-plate may be biased upwards against extending downwards or outwards such that when the plunger is not pressed the drop-plate rises.

The movable seal may further comprise a housing, and one or more drop-plate bias springs. The drop-plate bias springs may be arranged between the housing and the drop-plate.

The movable seal may comprise one or more apertures therethrough for receiving fixings for fixing a bolt support to a door. The drop-plate may comprise elongate apertures such that the drop-plate moves with the fixings therethrough.

The present invention further provides a door securing system comprising the movable seal set out herein and a bolting system comprising a vertically movable bolt arranged to be thrown vertically downwards to secure the bottom of a door and a bolt-support, the vertically movable bolt constrained by the bolt-support.

The present invention further provides a door comprising the movable seal set out herein or the door securing system out herein.

### BRIEF DESCRIPTION OF THE DRAWINGS

Embodiments of the present invention, and aspects of the prior art, will now be described with reference to the accompanying drawings, of which:

FIG. 1 is a perspective drawing of a door opened in a door frame, the door having fitted thereto a door seal according to the present invention;

FIG. 2A is a perspective drawing of the door seal shown in FIG. 1, and FIG. 2B is an exploded perspective drawing of the door seal;

FIGS. 3A-3E are plan views showing the layering steps of assembling the door seal;

FIGS. 4A and 4B are perspective views of the door seal with the drop-plate respectively retracted and extended, with some components removed for clarity;

FIGS. 5A-5D are plan views of the door seal with the drop-plate retracted in FIGS. 5A and 5B and extended in FIGS. 5C and 5D, with some components removed for clarity;

FIG. 6 is a perspective drawing of the door seal fitted to a door with a floor bolt; and

FIG. 7 is an exploded view of a door seal modified to accommodate fixings for a guide for the floor bolt.

### DETAILED DESCRIPTION

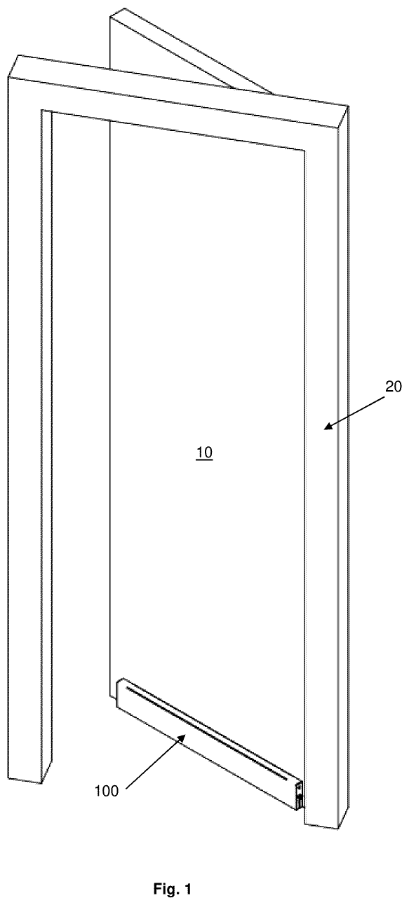

FIG. 1 shows a door 10 opened in a door frame 20. At the foot of the door is mounted a security door seal according to the present invention. The door is hinged at one side (the right hand side in the figure) and the other side of the door is the opening side (the left hand side in the figure). A plunger extends from the housing of the security door seal. The plunger is arranged at the hinged side of the door. When the door closes the plunder pushes against the door frame or door jamb pushing the plunger in, which causes the security door seal to drop and close a gap between the base of the door and the floor.

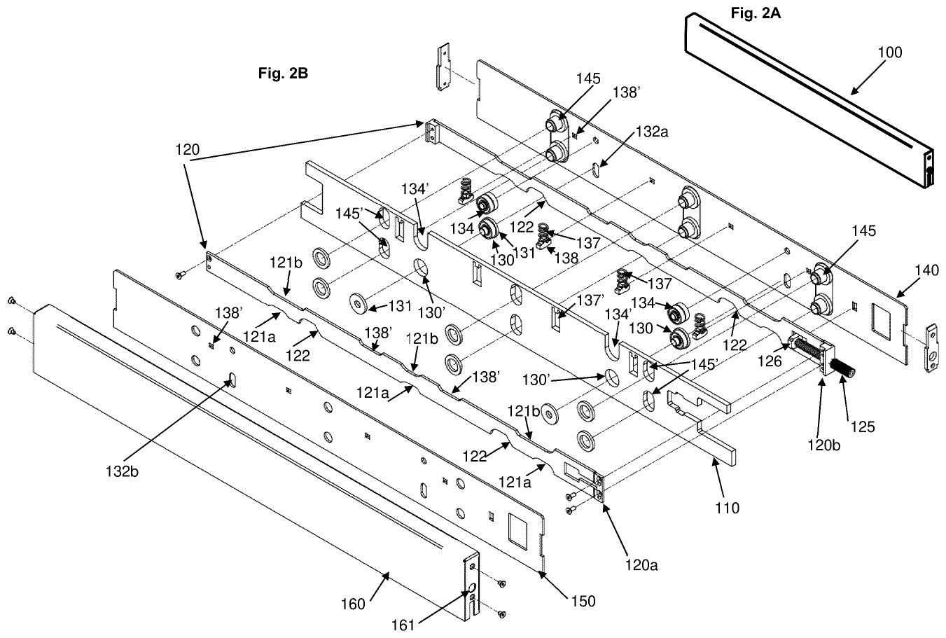

FIG. 2A shows the security door seal 100 similarly to FIG. 1 but without the door. FIG. 2B is an exploded perspective view of the security door seal. The security door seal 100 comprises drop-plate 110 which is the part of the security door seal that moves to close or cover a gap at the base of the door. Plunger can be seen at 125 in the figure extending so as to be pushed against a door frame or doorjamb. The plunger 125 is coupled to slider 120 for lateral movement when the plunger is depressed. The slider 120 comprises one or more ramp surfaces 122. One or more first rollers 130 push against the ramp surfaces 122 when the slider moves laterally. The rollers are coupled to the drop-plate and move downwards pushing the drop-plate downwards when the slider moves laterally. The two first rollers are preferably evenly distributed from the ends of the drop-plate and/or slider.

As shown in FIG. 2B the slider 120 is elongate and may be comprised of two parallel pieces such as plates 120a and 120b. The slider comprises a number of cut-outs or recesses in its edges which we will describe later. In the embodiment of FIG. 2B the drop-plate 110 is arranged between the two plates of the slider 120. The drop-plate comprises a number of apertures for receiving the rollers therethrough. A mounting plate 140 is shown for mounting the security door seal to the door. The mounting plate 140 may have a number of rollers mounted thereto. A front support plate 150 is shown which includes holes for supporting the rollers. Various rollers are mounted between the mounting plate 140 and the front support plate 150. A housing or casing 160 provides the outside appearance of the security door seal and has an aperture 161 through which plunger 125 extends. Adjacent to the front and back surfaces of the drop-plate are the parallel plates 120a, 120b, of the slider. The drop-plate may be thicker than the plates of the slider 120. The first rollers 130 have a first portion, which may be considered to be a central portion, which locates in holes 130′ in the drop-plate. The first rollers also have one or more second portions, such as end portions 131, which can rotate relative to the first portion. The second portions may have a greater diameter than the first portion. The first rollers 130 may rotate about a spindle or axis. The ends of the spindle are respectively held in slots 132a in the mounting plate 140 and 132b in the front support plate 150. The slots guide movement of the first rollers 130 up and down and hence correspondingly guide movement of the drop-plate 110. In the embodiment of FIG. 2B two such first rollers are provided but other numbers and arrangements or rollers are possible. Additionally, further rollers 134 may be provided. These further rollers 134 are held between the mounting plate 140 and front support plate 150 by having a spindle or axis located in respective holes therein. The drop-plate 110 has a channel or slot 134′ which the further rollers 134 are located in. When the drop-plate moves downwards the further rollers do not also move downwards but guide the direction of the downward movement by the faces of channel of slot 134′ moving against the rollers 134.

Second rollers 145 are also shown in FIG. 2B. In the embodiment of FIG. 2B six second rollers 145 are shown. The six rollers are arranged in pairs with a first pair towards a first end, or distal end, of the security door seal and a second pair towards a second or end proximal to the plunger of the door seal. A third pair of second rollers are provided towards the mid-length position of the door seal. In alternative embodiments, other numbers of second rollers may be provided. The second rollers are preferably evenly distributed along the length of the slider for even guiding of the movement of the slider. For example, the mid-length ones may be omitted. As mentioned, the second rollers are held on spindles or axes between the mounting plate 140 and front support plate 150. The second rollers have a central part that is narrower than the outer parts. The outer parts are similar to washers and can rotate separately to the central parts. The central parts are of smaller diameter than the washers and the central parts are a slide fit into the elongate channels or slots 145′ of the drop-plate, whereas the washers roll along recesses 121a and 121b. The slots and rollers guide the downward movement of the drop-plate with position of the slot moving downward with respect to the roller when the drop-plate drops. The second rollers 145 are arranged in pairs with one of each pair above the other. The drop-plate 110 is biased upwards, in other words against being in the lowered or dropped position. The bias is provided by springs such as coiled springs 137. In the embodiment of FIG. 2B with the slider formed of two parallel plates the springs are provided between the two plates. The springs 137 are located in slots 137′ in the drop-plate 110. A spring support beam 138 extends between the mounting plate 140 and front support plate 150 and fits into respective holes 138′ therein, and through the slots 137′ in the drop-plate. The bottom of the spring pushes against the spring support beam 138 and the top of the spring pushes against the top of the slot 137′ in the drop-plate 110. Hence, the springs 137 are arranged to push the drop-plate upwards by pushing against the spring support beams. In FIG. 2B four springs and support beams are provided distributed along the length of the drop-plate but other numbers of springs may be used. If using fewer springs they may need to be stiffer to be able to lift the drop-plate. By having the slider 120 formed of two plates with the drop-plate between them allows a balanced and centred bias and movement to the drop-plate. If the slider was a single plate then the movement would be offset to the side of the slider which over time could result in bending of components and jamming of the components. The slider 120 has a number of recesses in which the rollers move. As mentioned, the slider may be formed of two parallel plats 120a, 120b. The two plates comprise the same-shaped recesses. Some recess are also provided against which the bias springs act. Second rollers 145 are received in recesses 121a and 121b, with recesses 121b at the top edge of the slider for the top one of the pairs of second rollers and recesses 121a at the bottom edge for the bottom one of the pairs of second rollers. As in the embodiment shown in FIG. 2B there are three pairs of second rollers there are correspondingly three pairs of recesses. The recesses allow the rollers to be brought closer together thereby allowing the door seal to be more compact without compromising strength as might be the case if the whole slider was made the width at the recesses. Recesses 121b at the top edge of the slider are longer than those at the bottom. This is to allow space to fit the spring support beams 138 which cross through the slider at these points. At places along the slider where there is no roller but a spring support beam 138 passes, a separate recess 138′ is provided. In FIG. 2A there are four springs 137, with two of the spring support beams passing in recesses 121b and two passing recesses 138′. The lower edge of the slider comprises the recesses 122 with the ramp surfaces for driving the drop-plate downwards. Two such recesses are shown in FIG. 2B. These recesses are deeper than recesses 121a and the ramp surface 122, which is a slope, is formed at the end of the recess closest to the plunger 125.

Plunger 125 is formed of a rod. The outer section of the rod, that is the section extending from the seal to push against the door frame, is a larger diameter. This section may also be knurled. A mid-section of the rod is a smaller diameter and is threaded to fit in a threaded hole in an end part of the slider. By turning the outer knurled section of the rod the plunger may be screwed in or out to increase or decrease the length extending from the door seal casing. This allows the amount the plunger is pushed by the door frame and when the plunger hits the door frame to be adjusted. The inner end of the rod is not threaded and passes through a hole in plunger guide support 126. The plunger guide support extends between mounting plate 140 and front support plate 150 and is held in holes therein. Between the end part of the slider and the plunger guide support 126 is a spring to bias the plunger and slider to push the plunger outwards. The slider plates 120a and 120b have holes to accommodate the plunger guide support and allow the slider to move. The drop-plate also includes a cut-out around the plunger to allow movement of the plunger.

The drop-plate may have a 5-20 mm drop range such as around 10 mm or around half an inch. This actual drop range is adjustable by adjusting the amount the plunger is pushed in when the door is closed.

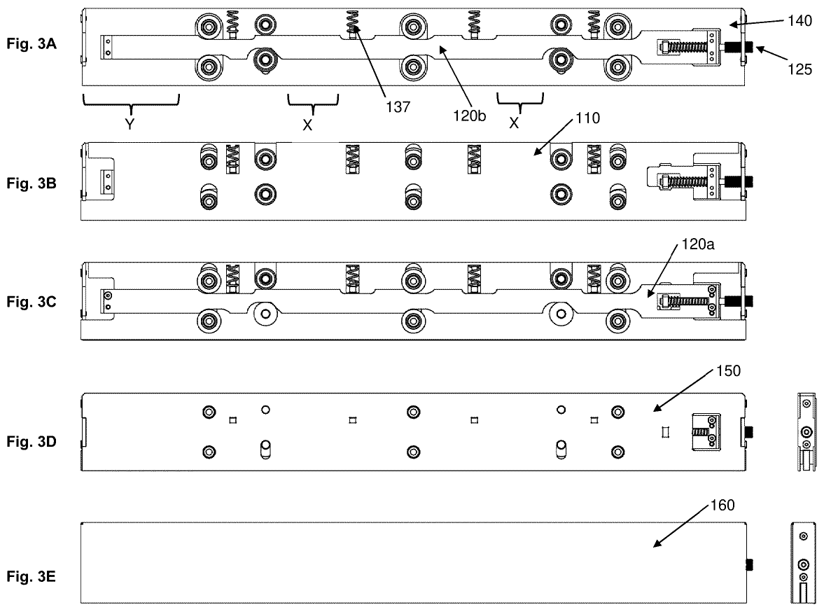

FIGS. 3A to 3E show steps in the assembly of the various layers of the security door seal. FIG. 3A shows the mounting plate 140 with one of the plates 120b of the slider 120 fitted. Various rollers, the spring biases 137 and plunger 125 are also shown. In FIG. 3B the drop-plate 110 is added and in FIG. 3C the other 120a of the two plates of the slider 120 is added. FIG. 3D shows the front support plate 150 as a further layer fitted. In FIG. 3E the housing or casing is fitted over the front support plate to complete the assembly.

The housing or casing also includes a hole for the plunger to extend through. The housing or casing 160 may include a front face, top face and two end faces. A bottom face is not included because the drop-plate moves to extend out through the bottom of the door seal.

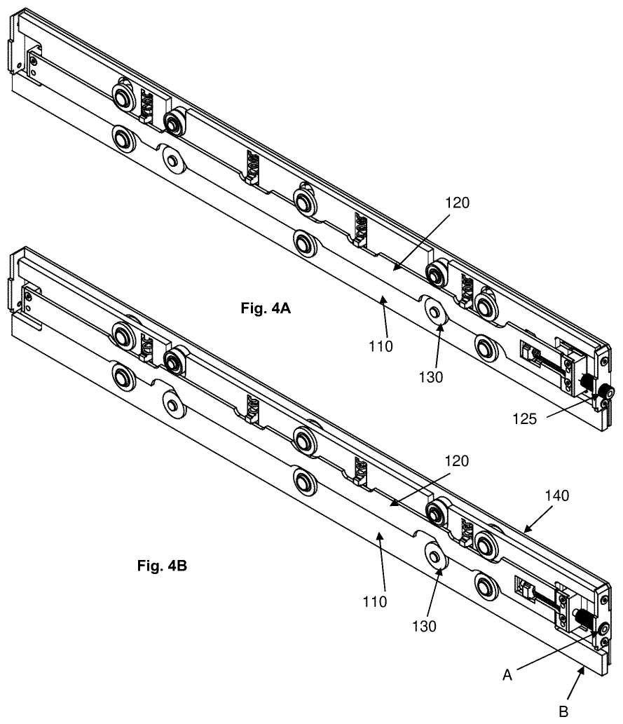

Turning to FIGS. 4A and 4B, these figures are isometric views of the door seal with the front support plate 150 and housing 160 removed. FIG. 4A shows the door seal with the plunger 125 extended and the drop-plate retracted. FIG. 4B shows the door seal with the plunger pushed in and the drop-plate extended downwards. By comparing FIGS. 4A and 4B, it can be seen that the plunger 125 is pressed in (as indicated by arrow A). This has pushed the slider back (to the left in the figure). The ramp surface 122 of the slider pushes against first roller 130 which is attached to the drop-plate 110. As the slider is pushed back the ramp surfaces push the roller 130 downwards thereby pushing drop-plate downwards, as can be readily seen at the right hand side of the figure (indicated by B) where the drop-plate has lowered beyond the bottom of the mounting plate 140.

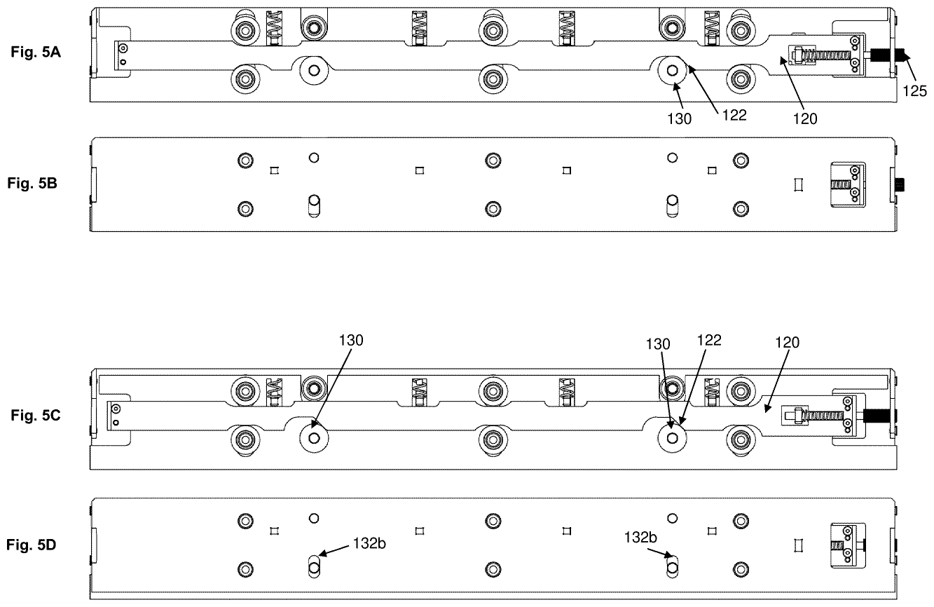

FIGS. 5A-5D are plan views of the security door seal showing the change in positions from the drop-plate being retracted (FIGS. 5A and 5B) to being extended (FIGS. 5C and 5D). FIGS. 5A and 5C are similar to FIG. 4A in that the front support plate 150 and housing 160 are removed. FIGS. 5B and 5D only have the housing 160 removed. In FIGS. 5C and 5D the plunger 125 has been pushed in, driving the slider back. The ramp surfaces again have pushed against first rollers 130 pushing the drop-plate downwards. In FIG. 5D the movement of the two first rollers 130 downwards can be seen by the spindles or axes having moved downwards in slots 132b.

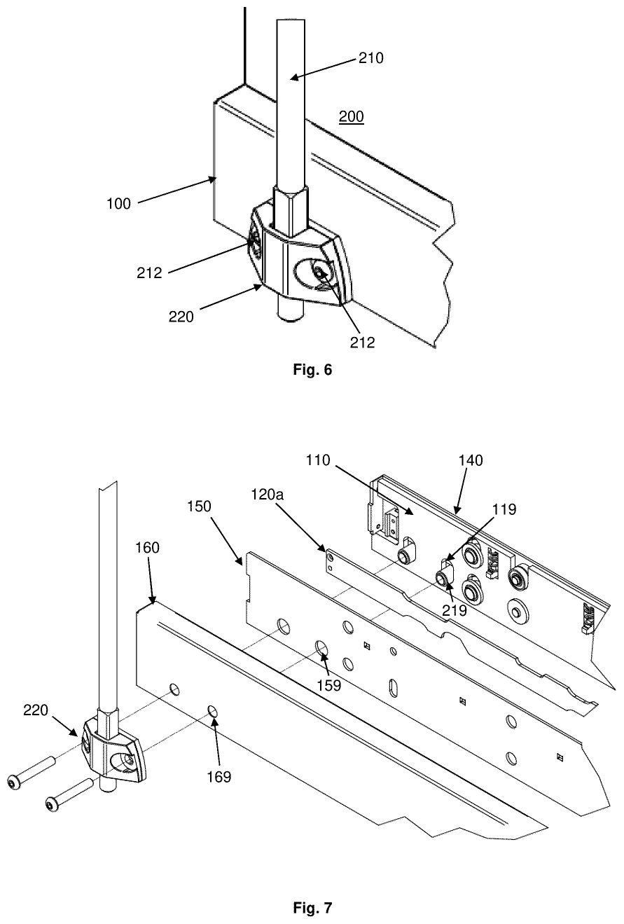

Multi-point bolting systems may include a bolt for securing the door against the floor as well as bolts for securing the door at the side and top. Typically, a floor bolt would be supported by a guide towards the base of the door and the guide would be fixed to the door by two or more screws or fixings. As the guide is usually mounted close to the bottom edge of the door this may not be possible if a door seal was fitted to the door because the door seal extends across the full width of the door and will be in the way of the bolt and bolt guide. In the embodiment of FIG. 6 this has been resolved and shows a bolt guide 220 fitted over the security door seal 100. The added thickness to the door 200 of the door seal 100 may require that the bolting system is fitted to the door with spacers to align the bolt 210 with the bolt guide. To fix the bolt guide to the door the door seal needs to accommodate fixings 212 such as screws or bolts.

FIG. 7 is an exploded view of a door seal according to the present invention that is modified to accommodate the fixings 212. Housing or casing 160 includes holes 169 for receiving the fixings. Similarly, front support plate 150 has holes 159. Preferably the position of the guide 220 is such that the slider 120 does not need to be modified with holes because the guide is fitted below the position of the slider. The drop-plate has holes 119 for receiving the fixings. However, because the drop-plate moves the holes 119 are elongated whereas those in the casing may be circular. Spacers 219, such a short tubes, may additionally be included to avoid the fixings clashing with the internal components of the door seal during fitting. Accordingly, a security door seal may be provided in combination with a multi-point bolting system with a floor bolt.

The security door seal has been designed with a view that the size of the door seal can be changed to fit different width doors by simply extending dimensions and without requiring significant redesign. The security door seal preferably extends the full width across the door such that no gaps are left under the door. FIG. 3A shows two regions “X” in the door seal. At these regions there are no rollers, recesses, ramps or springs. Hence, for increasing or decreasing the width of the door seal the width of these regions X may be increased or decreased. Alternatively, for minor changes in the length of the door seal, only the length of the back end “Y” of the door seal may be changed. However, it is preferable to keep the positioning of the rollers evenly distributed along the length of the door seal such that the drop-plate is driven downwards with evenly distributed force along its length.

Although we have described that the door-seal is a security door seal to prevent wires, fibre optics or other items from being fed under a door, the door seal also has other applications. For example, the door seal may also provide a weather seal stopping wind and rain such as during tornados or hurricanes from ingress to the indoor. The door seal may form a flood seal stopping flood waters from entering a building through the doorway. To provide an effective seal the drop-plate may be provided with a rubber sealing strip at its bottom edge to fill small gaps to the floor along its length. In a further alternative arrangement the door seal may complete an RF seal or Faraday cage preventing RF signals from entering a room. In such a case the door may be a metal door. In a further arrangement the door seal may be an acoustic seal reducing or preventing sound from entering a room by passing under the door.

The person skilled in the art will readily appreciate that various modifications and alterations may be made to the above described bolting mechanism. The modifications may be made without departing from the scope of the appended claims. For example, the first and second key cylinders may be positioned differently. The gears of the drive mechanism may be configured differently such as without teeth but to drive each other by lever action or the use of a belt or chain. The solenoid may be replaced with a motor such as a worm drive motor providing linear movement in a similar manner to the solenoid. Furthermore, variations in the actual shapes of the parts such as the sliding deadbolt, cams, and bolt may be made without diverging from the general scope of the present invention.

What is claimed:

1-14. (cancel)

15. A movable seal for mounting to a door, the moveable seal comprising:
a drop-plate configured to move to close or cover a gap between a bottom of a door and a floor;
a plunger extending laterally configured to be pressed by a door frame as the door closes;
a slider arranged to be moved laterally by the plunger when the plunger is pressed, the slider having one or more ramp surfaces; and
one or more first rollers,
wherein the slider is configured such that when pushed laterally by the plunger the one or more ramp surfaces push against the one or more first rollers moving the drop-plate transversely to extend the drop plate outwards for closing or covering the gap to the floor.

16. The movable seal of claim 15, wherein the one or more first rollers are coupled to the drop-plate and configured such that as the slider moves laterally the ramp surfaces push against the first rollers pushing the plate outwards.

17. The movable seal of claim 15, further comprising:
a mounting plate for mounting the movable seal to a door; and
one or more second rollers coupled to the mounting plate for guiding the lateral motion of the slider.

18. The movable seal of claim 17, wherein the one or more second rollers comprise one or more pairs of second rollers with the rollers in a pair of second rollers arranged on opposing sides of the slider to constrain motion of the slider substantially laterally.

19. The movable seal of claim 18, wherein the one or more pairs of second rollers comprise at least two pairs of second rollers, a first pair of second rollers arranged towards a first end of the slider and a second pairs of second rollers arranged towards a second end of the slider.

20. The movable seal of claim 17, wherein the slider comprises parallel recesses and the second rollers are arranged to roll along the parallel recesses.

21. The movable seal of claim 15, wherein the slider comprises two parallel plates with the drop-plate there between.

22. The movable seal of claim 15, wherein the plunger comprises a rod biased to extend from the slider to be pressed by a door frame.

23. The movable seal of claim 22, wherein the rod of the plunger has a threaded portion extending through a threaded hole in the slider for adjusting the extent the plunger extends.

24. The movable seal of claim 15, wherein the drop-plate is biased upwards against extending outwards such that when the plunger is not pressed the drop-plate rises.

25. The movable seal of claim 24, further comprising a housing, and one or more drop-plate bias springs, the drop-plate bias springs arranged between the housing and the drop-plate.

26. The movable seal of claim 15, comprising one or more apertures therethrough for receiving fixings for fixing a bolt support to a door, wherein the drop-plate comprises elongate apertures such that the drop-plate moves with the fixings therethrough.

27. A door securing system comprising the movable seal of claim 26 and a bolting system comprising a vertically movable bolt arranged to be thrown vertically downwards to secure the bottom of a door and the bolt-support, the vertically movable bolt constrained by the bolt-support.

28. A door comprising the movable seal of claim 15.

29. A door comprising the door securing system of claim 27.
